(19) United States
(12) Patent Application Publication
(10) Pub. No.: US 2020/0317550 A1
(43) Pub. Date: Oct. 8, 2020

(54) Passive, Tunable Biocide Delivery System

(71) Applicant: BOARD OF TRUSTEES OF THE UNIVERSITY OF ARKANSAS, Fayetteville, AR (US)

(72) Inventors: Robert Beitle, Fayetteville, AR (US); Tanner C. Burns, Fayetteville, AR (US); Jennifer Gaines, Fayetteville, AR (US); Rogelio Elias Garcia, Fayetteville, AR (US); Scott Perry, Van Buren, AR (US); Eric R. Beitle, Fayetteville, AR (US)

(73) Assignee: BOARD OF TRUSTEES OF THE UNIVERSITY OF ARKANSAS, Fayetteville, AR (US)

(21) Appl. No.: 16/838,894

(22) Filed: Apr. 2, 2020

Related U.S. Application Data
(60) Provisional application No. 62/830,069, filed on Apr. 5, 2019.

(51) Int. Cl. C02F 1/68; C02F 1/44; C02F 1/50

(52) U.S. Cl. CPC C02F 1/685; C02F 1/44; C02F 1/505; C02F 2301/046; C02F 2201/006; C02F 2201/005; C02F 2209/05; C02F 2303/04

(57) ABSTRACT

A biocide delivery system comprising a feed tank in communication with a biocide source containing a biocide; said biocide source adapted to receive water from said feed tank and controllably releases biocide into water received from said feed tank; and a product tank in communication with said biocide source and adapted to receive water from said biocide source.

### RELATED APPLICATIONS

This application claims priority to U.S. Provisional Application No. 62/830,069 filed on Apr. 5, 2020, which is incorporated herein by reference.

### STATEMENT REGARDING FEDERALLY SPONSORED RESEARCH & DEVELOPMENT

Not applicable.

### INCORPORATION BY REFERENCE OF MATERIAL SUBMITTED ON A COMPACT DISC

Not applicable.

### BRIEF SUMMARY OF THE INVENTION

In one embodiment, the present invention is capable of delivering a biocide, such as silver, copper, or iodine, that requires little or no power and can work in microgravity.

In other embodiments, the present invention uses a membrane that acts as a controlled delivery device and a bypass to adjust the concentration of the biocide in a potable water stream.

In other embodiments, the present invention uses different membranes and/or formats such as flat sheet, hollow fiber, or spiral.

In other embodiments, the present invention provides water treatment systems for use in manned space explorations and other extraterrestrial applications.

In other embodiments, the present invention provides a passive means of biocide delivery for use in circumstances with no or low power and microgravity.

In other embodiments, the present invention may be integrated into current water treatment systems.

In other embodiments, the present invention provides a membrane system that may be used with resin beds which capture silver.

In a preferred embodiment, the present invention provides systems and methods of silver delivery that use controlled release methods. The release of silver by a membrane cartridge or resin bed allows for a consistent release of silver ions at the desired concentration range to meet predetermined requirements.

In other embodiments, the present invention uses a membrane that acts as a controlled delivery device and a bypass to adjust the concentration of the biocide in the portable water stream. Current means of microbial control rely on the use of iodine as part of the methodology, which can lead to major health concerns such as hypothyroidism.

In other embodiments, the present invention may be used to provide a portable water treatment modality for Waste-Management in space.

In other embodiments, the present invention provides a safer method/technology for water remediation and microbial control and a novel solution to current systems/infrastructure which replaces the use of problematic iodine with a process that uses silver.

In other embodiments, the present invention provides a filter-based membrane delivery system where biocide is slowly dissolved into the system.

In other embodiments, the present invention a new design and use of a silver-based method membrane that removes the toxic iodine from the process and dilutes silver into the water via the use of traditional dialysis filters while still retaining the important factors related to a safe and efficient process.

In other embodiments, the present invention provides a biocide delivery system comprising: a feed tank in communication with a biocide source containing a biocide; the biocide source adapted to receive water from the feed tank and controllably releases biocide into water received from the feed tank; and a product tank in communication with the biocide source and adapted to receive water from the biocide source.

In other embodiments, the present invention provides a biocide delivery system comprising: a feed tank in communication with a first biocide source containing a biocide; the first biocide source adapted to receive water from the feed tank and controllably releases biocide into water received from the feed tank; a second biocide source containing a biocide in communication the first biocide source, the second biocide source controllably releases biocide into water received from the first biocide source; a third biocide source containing a biocide in communication the second biocide source, the third biocide source controllably releases biocide into water received from the second biocide source; and a product tank in communication with the third biocide source and adapted to receive water from the third biocide source. The first, second and third biocide sources may contain silver as the biocide. Also, the biocide delivery system may further include a plurality of valves in communication with the second biocide source, the plurality of valves form a feedback loop adapted to recirculate water within the second biocide source. Also, the system may include a fourth biocide source in communication with the second biocide source, the fourth biocide source replenishes biocide released by the second biocide source.

In other embodiments, the present invention provides a method of treating water with a biocide comprising the steps of: providing a feed tank in communication with a first biocide source containing a biocide; adapting the first biocide source to receive water from the feed tank and to controllably release biocide into water received from the feed tank and to controllably release biocide into water returned to the feed tank; providing a second biocide source containing a biocide in communication the first biocide source, the second biocide source controllably releases biocide into water received from the first biocide source; providing a third biocide source containing a biocide in communication the second biocide source, the third biocide source controllably releases biocide into water received from the second biocide source and to controllably release biocide into water returned to the second biocide source; and providing a product tank in communication with the third biocide source and adapted to receive water from the third biocide source. The method may also include the step of including a plurality of valves in communication with the second biocide source, the plurality of valves form a feedback loop adapted to recirculate water within the second biocide source. The method may also include the step of further including a fourth biocide source in communication with the second biocide source, the fourth biocide source replenishes biocide released by the second biocide source. Lastly, a conductivity meter may be used to control the operation of at least one of the valves.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1 illustrates a first embodiment of the present invention.

FIG. 2 illustrates bacterial absorbance in solution with silver ions at 50 and 1500 ppb from silver lactate or silver citrate.

FIG. 3 depicts the release rate of Ambersep IRC748 Ag+.

FIG. 4 illustrates Ag+ release over time from Membrane I.

FIG. 5 illustrates the measured Ag+ release from Membrane II.

FIG. 6 illustrates the measured release of Ag+ from Membrane III.

FIG. 7 illustrates bacterial absorbance versus time for silver ions.

FIG. 8 illustrates a second embodiment of the present invention

FIG. 9 illustrates a calibration curve of the embodiment shown in FIG. 8.

FIG. 10 illustrates a first set of results for the embodiment shown in FIG. 8.

FIG. 11 illustrates a second set of results for the embodiment shown in FIG. 8.

FIG. 12 illustrates a third set of results for the embodiment shown in FIG. 8.

FIG. 13 is a comparison of the results shown in FIGS. 10-12.

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure or system. Further, the terms and phrases used herein are not intended to be limiting, but rather to provide an understandable description of the invention.

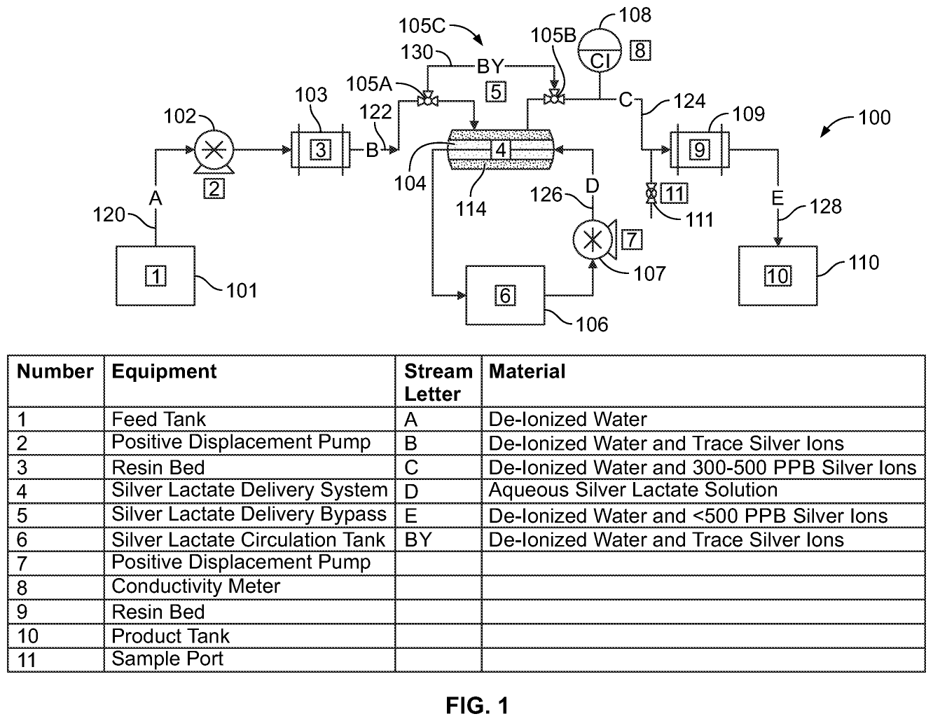

In one embodiment, the present invention provides systems and methods of biocide delivery that use controlled release methods. In one preferred embodiment, as shown in FIG. 1, a biocide delivery system 100 is provided which may be a silver delivery system (SDS). System 100 may be comprised of feed tank 101, positive displacement pump 102 that provides proper flow even in microgravity situations. Also provided is a first biocide source 103 which may be a resin bed, membrane or cartridge containing the biocide.

First biocide source 103 functions to release biocide into stream 122. It also functions to prevent microbial back contamination of the potable water that occurs during backflow or stagnant conditions (microorganisms can diffuse in the opposite direction of normal flow) as it will add biocide to any backflow as well.

In other embodiments of the present invention, a biocide concentrator system may also be provided with the present invention. For an exemplary embodiment using silver lactate, the biocide concentrator system includes second biocide source 104 which may be a source of silver lactate stored in a membrane, cartridge or resin bed. Second biocide source 104 is located in chamber 114 which contains the water to be treated. Other biocides may also be used. Also included are bypass valves 105A and 105B forming bypass stream 105C. The biocide concentrator system may also include circulation tank 106 which functions as a stored source of silver lactate and positive displacement pump 107.

The final components of system 100 further include conductivity meter 108, third biocide source 109 which may be a resin bed, membrane or cartridge containing the biocide and finished product tank 110. Lastly, sample port 111 may also be included. Third biocide source 109 functions to release biocide into stream 128. It also functions to prevent microbial back contamination of the potable water that occurs during backflow or stagnant conditions (microorganisms can diffuse in the opposite direction of normal flow) as it will add biocide to any backflow as well.

As deionized water in stream 120 flows from feed tank 101 to first resin bed 103, trace of amounts of biocide are added, which may be silver. Stream 122 is outputted as deionized water containing trace silver ions to the biocide concentrator system.

The biocide concentrator system is adapted to release biocide in a controlled manner through second biocide source 104 into the water to be processed in chamber 114. Bypass 105C functions to tune the final concentration of silver, or other biocides, through the recirculation of stream 130 which contains deionized water containing trace silver ions. If it is determined that the concentration of biocide is too low, bypass 105C operates by reducing or stopping the flow of water through valve 105B thereby recirculating water within second biocide source 104 to increase the concentration of biocide in the water. Once proper levels are detected by conductivity meter 108, processed water is released as stream 124. Biocide circulation tank 106 and positive displacement pump 107 together function to create a biocide charging loop/reservoir, which may be an aqueous silver lactate solution 126 for use by second biocide source 104. In other words, biocide circulation tank 106 may act as a fourth biocide delivery source that replenishes biocide released from second delivery source 104.

Control by conductivity meter 108 allows for the process of water to reach the optimal 300-500 ppb concentration as stream 124. To maintain a desired concentration of biocide, valve 105B does not release water as stream 124 until the desirable concentration/conductivity is achieved at meter 108 through the use of the biocide concentrator system.

Finally, second resin bed 9 serves as a microbial check valve (MCV) to create stream 128 of deionized water having less than 500 ppb silver ions.

Water Treatment Resins

Ion-exchange resins effectively adsorb contaminants that are present in water, exposing them to silver within the resin bed. A consistent concentration of biocidal silver ions is required to prevent bacterial in-line contamination through backflow from an MCV. Two ion-exchange resins may be used with the embodiments of the present invention: AMBERSEP™ IRC748 and AMBERSEP™ GT74. The IRC748 resin is made up of a styrene-divinylbenzene matrix with an iminodiacetic acid functional group, which is effective at removing metals from water. The GT74 resin has a styrene-divinylbenzene matrix as well but includes a thiol functional group. The GT74 resin effectively removes metals from water but also has a higher affinity for silver ions.

Microgravity Considerations

Since the present invention may be used in spacecraft, operation in microgravity must be achieved. To ensure a fully developed flow, positive displacement pumps were used. Air pockets within the piping system in space could cause an issue for the flow of water in the system. Using tubing with a small diameter, ensuring that there are no air bubbles throughout the system, and utilizing positive displacement pumps will minimize concerns about design performance in microgravity. If any design modifications are needed to account for microgravity, flow fluctuation could be modeled in COMSOL Multiphysics.

Biocidal Efficacy of Silver Solutions

The embodiments of the present invention are designed to eliminate or reduce microbes that exist within the system to ensure safe drinking water. To do this, a first result exposed E. coli to prepared solutions of 50, 250, 500, 750 and 1500 ppb silver lactate and silver citrate in deionized water. Inhibition of microbial growth was determined by using a spectrophotometer. Spectrophotometer readings were measured at an absorbance of 600 nm, a wavelength commonly used to quantify the growth of cells. The 1500 ppb solution of silver lactate and deionized water was created using 500 mL of deionized water and silver salts. Before subsequent dilutions were performed, the concentration of the 1500 ppb solution was checked using inductively coupled plasma mass spectrometry (ICP-MS) to confirm the lack of silver plating on containers. Once all dilutions were performed, the solutions were well mixed and measured out into 50 mL test tubes before introducing E. coli.

Approximately 2 mL of E. coli in lysogeny broth (LB) was mixed with the silver salt solutions and given approximately 3 hours to mix before data recordings were taken to determine the effectiveness of silver salts as antimicrobials.

Silver Ion Release Rate from Resins

Two chelating resins, one containing iminodiacetic and the other thiol groups, were loaded with silver. The AMBERSEP™ IRC748 and AMBERSEP™ GT74 resins are macroporous cation-exchange resins with pronounced selectivity for silver cations. The AMBERSEP™ IRC748 resin originally contains sodium cations while the AMBERSEP™ GT74 resin has hydrogen cations. A solution of silver lactate was prepared based on the total exchange capacity of the resins (1.35 eq/L). The silver solution (20 mL) was mixed with 2.25 grams of resin for one hour inside a 40 mL beaker. The resins were then filtered out using a sintered glass funnel and the supernatant solution was collected for ICP-MS. Furthermore, some drops of a concentrated sodium hydroxide solution were added to a small volume of the filtrate to quickly test for the presence of silver by looking for any silver hydroxide precipitate. After the resins were saturated with silver, a silver release rate test was performed. The resin was added to 300 mL of deionized water and the suspension was mixed for 3 hours in a baffled beaker. Conductivity measurements were obtained using a conductivity probe (SympHony SP70C) to measure the silver ion concentration. Each conductivity reading was repeated at least once, and the silver levels were calculated using a calibration curve.

Membrane Permeation Rates

Three types of membranes were used to form controlled delivery system 104, referred to as Membranes I, II, and III. Differences were in the composition of membrane and format. Membrane I was made from a Biotech cellulose ester dialysis membrane (Spectrum™ Spectra/Por™) that successfully released a high concentration solution at a reasonable permeation rate. The cellulose ester sack dialysis membrane of Membrane I was loaded with a 1 g/L solution of silver ions and it was submerged in 450 mL of deionized water. The increase in silver concentration was determined by measuring the conductivity of the water in which Membrane I was immersed over five hours.

Membranes II and III are similar in configuration to continuous dialysis systems and functioned as a high concentration of silver reservoir that may be used to deliver silver ions at a controlled rate. Membrane II was charged with 20 g/L, whereas Membrane III contained a recirculating solution of 1 g/L silver salt.

Biocidal Efficacy of Silver-Loaded Resins

The AMBERSEP™ IRC748 resin that was previously loaded with silver was used for the initial growth inhibition tests. A 20 mL solution of E. coli bacteria in LB was combined with 100 mL of deionized water and 2 grams of the resin. The total solution was mixed in a baffled beaker with a magnetic stir bar for 5 hours. Using a syringe filter, the resin was removed from samples and the corresponding resin-free fluid was placed in a spectrophotometer to monitor E. coli growth every 15 minutes

Silver Solutions Bacterial Growth Inhibition Tests

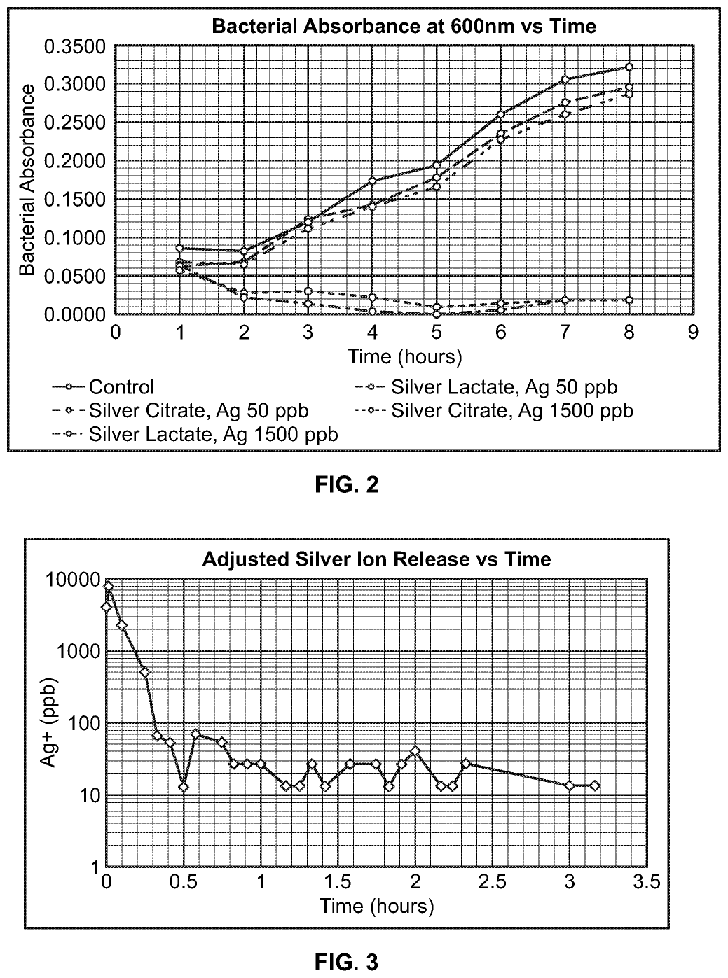

FIG. 2 shows the E. coli kill tests using silver salts at 1500 ppb and 50 ppb. In contrast to merely inoculating an aqueous solution of silver salt, LB was also present to simulate a (worst case) scenario whereby cells are provided a rich medium to grow. At 1500 ppb, silver lactate completely inhibited bacterial growth in as little as 3 hours while it took the silver citrate approximately 5 hours at the same concentration. At 50 ppb, neither of the salt solutions effectively eliminated E. coli, the bacteria continuously grew during the 8-hour result. With drinking water regulations and the design limit only allowing for 500 ppb of silver in water solutions, further results at lower silver concentrations were performed.

Table 1 shows the results for the second bacterial kill test using silver lactate and silver citrate at 250, 500 and 750 ppb. This test was performed similarly to the first. In total there were six test solutions plus a control, with the effectiveness of silver salts compared to the control of zero addition. As seen in Table 1, at any given concentration, silver lactate performed better than silver citrate in microbial growth suppression.

TABLE 1
Effectiveness of varying solutions of Ag+ in ppb from silver lactate
and silver citrate.

| | | 250 | 250 | 500 | 500 | 750 | 750 |
|---|---|---|---|---|---|---|---|
| | | ppb | ppb | ppb | ppb | ppb | ppb |
| | Con- | Silver | Silver | Silver | Silver | Silver | Silver |
| | trol | Citrate | Lactate | Citrate | Lactate | Citrate | Lactate |
| Initial | 0.069 | 0.031 | 0.035 | 0.031 | 0.022 | 0.022 | 0.019 |
| absorbance | | | | | | | |
| Average | 0.074 | 0.028 | 0.011 | 0.008 | 0.004 | 0.012 | 0.007 |
| absorbance | | | | | | | |

Resin Silver Release Rate

FIG. 3 contains the results that were obtained from the silver release result. The plot shows how much silver was lost from the resin per interval of time. The resins started delivering a relatively high amount of silver reaching concentration up to 7500 ppb during a short period, attributed to washout of loosely bound silver. A very low stripping of silver was consistently recorded after 15 minutes. The data reveals that the deionized water does not promote a significant stripping of silver.

Silver Release in Membrane Systems

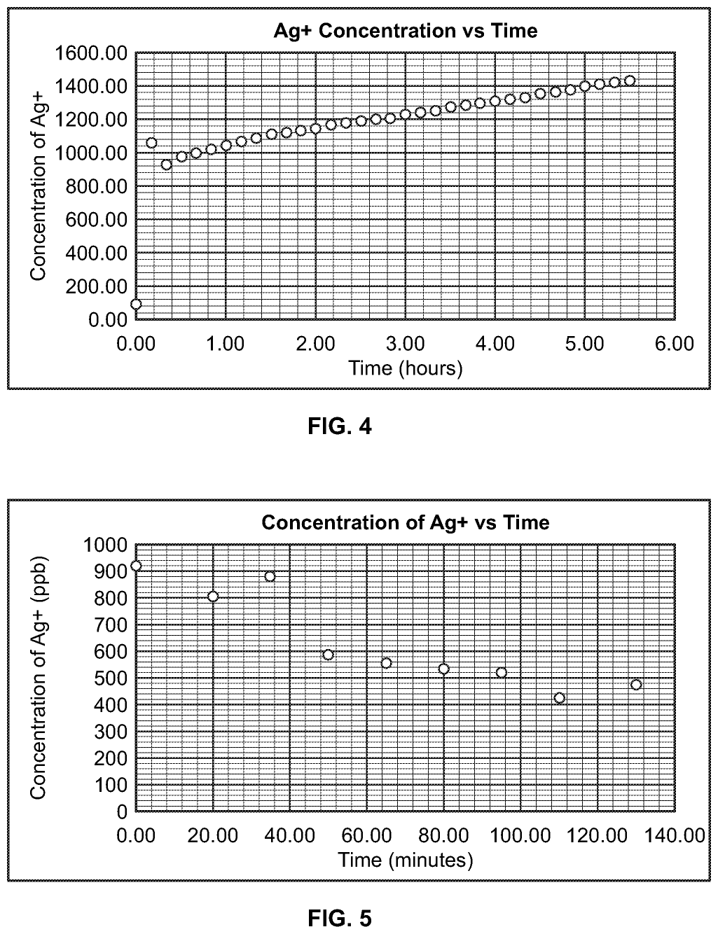

A test was performed to examine the feasibility of silver release from a dialysis membrane. Membrane I had a molecular weight cutoff of 100,000. Based on the consistent release of ions from the dialysis membrane shown by the Ag⁺ release rate graphed in FIG. 4 and the average release values of Table 2, the dialysis membrane acted as an effective delivery vehicle for Ag⁺.

TABLE 2
Average release, flux, and amount of AG+
released by the membrane I.
Average Release Ag+
concentration (μg/L)
15.19
Surface area (m²)
0.01
Average Released Ag+ (mol)
6.33E−08
Time interval of Ag+ release (s)
600.00
Ave. Ag+ Flux (mol/m²s)
1.66E−08

After obtaining this data with a simple dialysis arrangement, more complex membrane formats were tested.

The system designated as Membrane II yielded the diffusion data shown in FIG. 5. It released silver at a fairly consistent rate over time and delivered silver ions within the desired parts per billion limits. Due to the more complex design, silver ion concentrations can be controlled more easily and over a longer period.

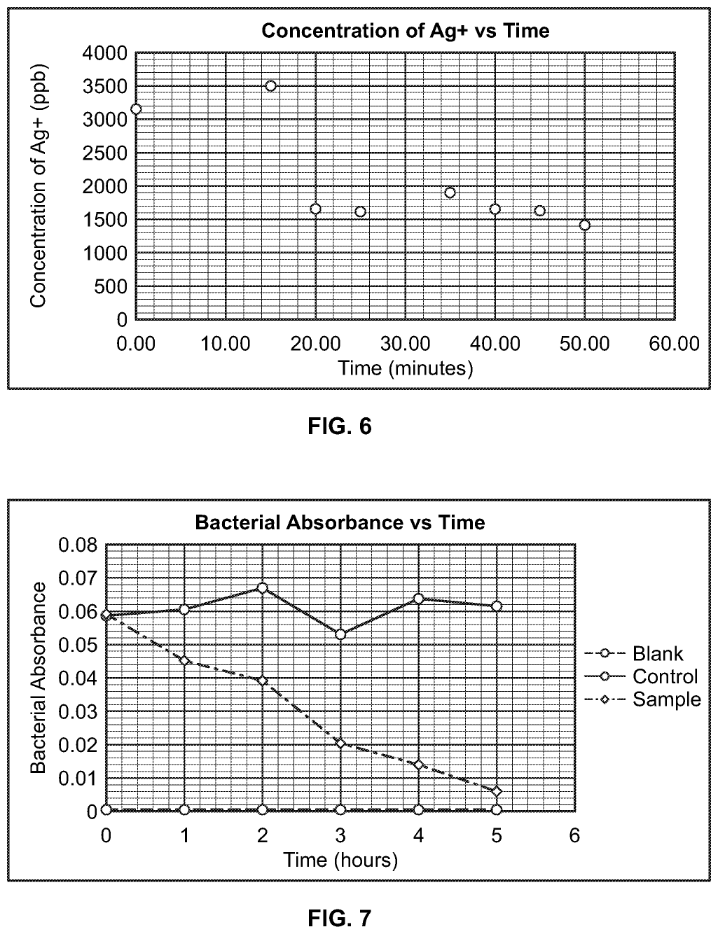

FIG. 6 shows the results for the system designated as Membrane III. System III was loaded with a 30 mL mixture of silver lactate and deionized water. The silver lactate solution that filled tube side 114, as shown in FIG. 1, of the membrane had a concentration of 20 grams per liter. Deionized water was continuously pumped through shell side 115, as shown in FIG. 1, and concentration measurements were taken after water passed through the shell. After an initial spike in concentration, there was a consistent release of 1750 ppb of silver ions into the water on the shell side of the dialysis membrane.

Silver-Loaded Resin Bacterial Kill Test

In FIG. 7, the results for bacterial growth inhibition tests are shown. The resin containing silver lactate was well mixed in a solution with E. coli and deionized water. This solution was tested against a water blank and a control made up of 19 mL of E. coli and 100 mL of deionized water with no silver present. In 5 hours, the silver-containing resin eliminated the E. coli completely from the mixed solution.

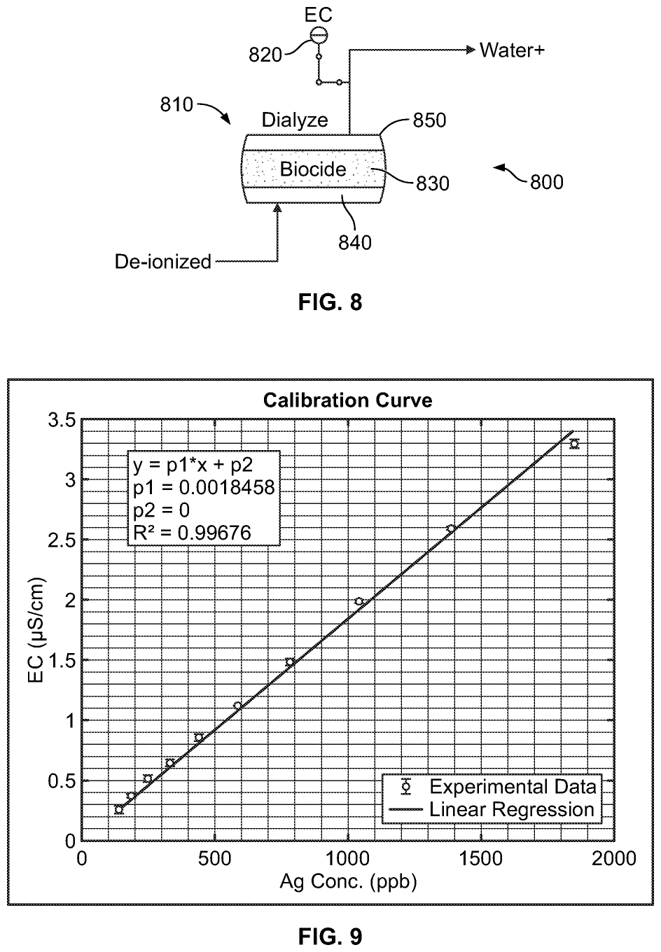

FIG. 8 shows a “Passive, Tunable Biocide Delivery System” (PTBDS) 800 which is an alternate embodiment of the present invention. System 800 includes dialyzer 810 which releases the biocide to the stream of water, and electroconductivity meter 820 that takes measurements at the outlet of the dialyzer. Dialyzer 810 may be a self-contained, disposable device that incorporates tubing 830 which may be a semi-permeable 20 kDa molecular cutoff membrane that separates the biocide solution from the surrounding flow-through chamber 840 created in housing 850.

FIG. 9 is a calibration curve obtained for the embodiment shown in FIG. 8 by taking electroconductivity readings at different concentrations of silver lactate (biocide source) in deionized water. This plot will help to determine the concentration of silver ions (biocide) that PTBDS 800 releases to a stream of water. These measurements were taken by using an Atlas Scientific Environmental Robotics Conductivity Probe K 0.1.

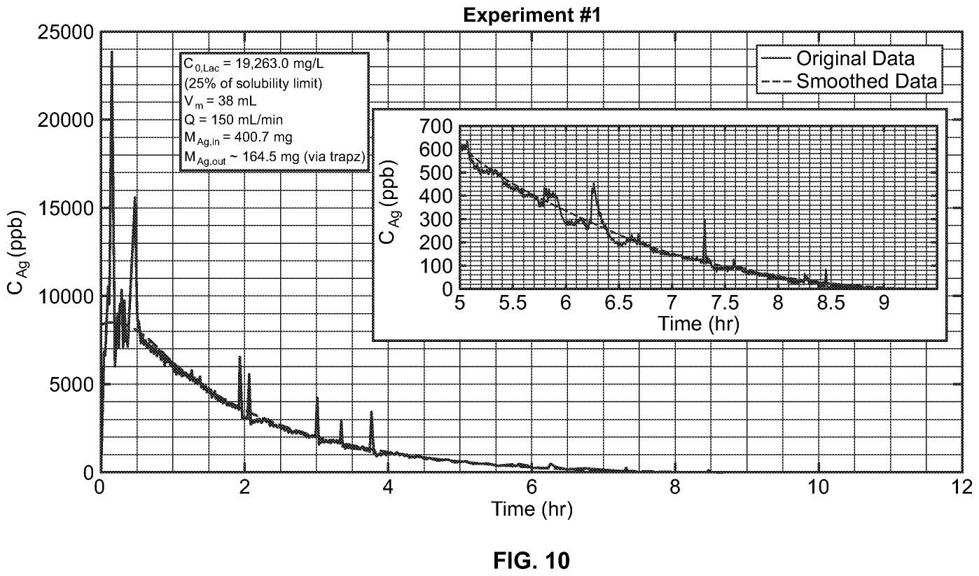

FIG. 10 is a plot showing how the concentration of biocide changes at the outlet of the dialyzer for 12 hours. The amount of biocide (in mg) that the dialyzer delivered after 12 hours was calculated using trapezoidal numerical integration.

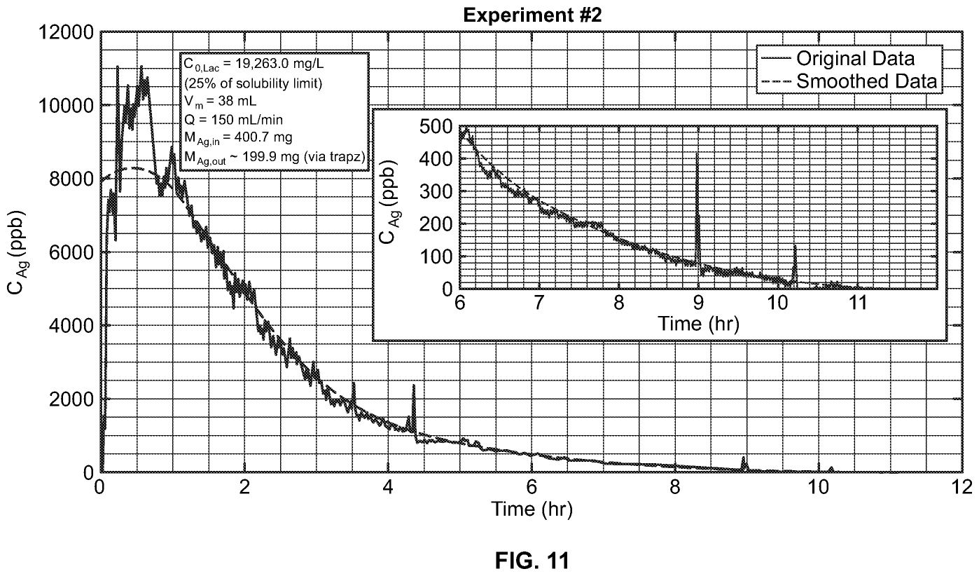

FIG. 11 is a plot showing how the concentration of biocide changes at the outlet of the dialyzer for 12 hours. The amount of biocide (in milligrams) that the dialyzer delivered after 12 hours was calculated using trapezoidal numerical integration.

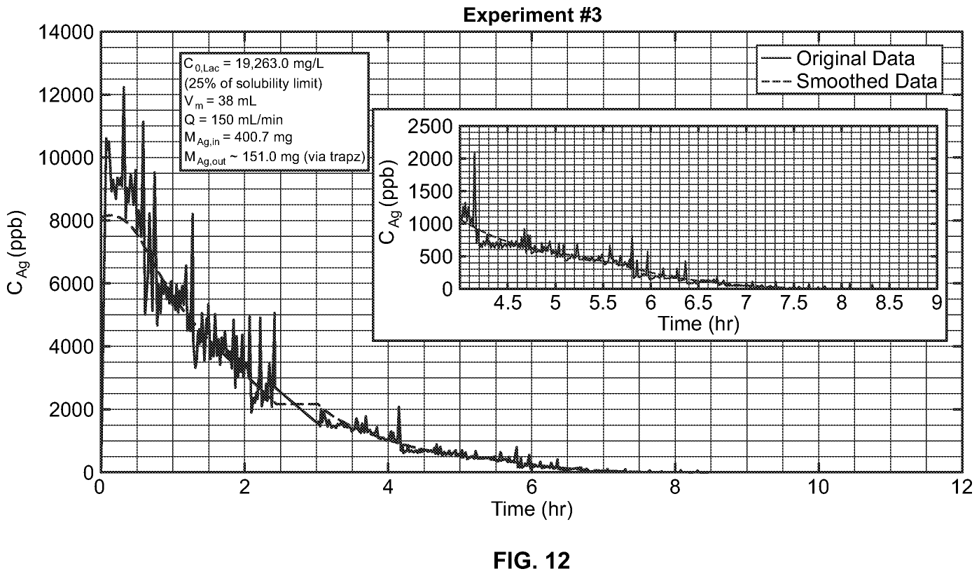

FIG. 12 is a plot showing how the concentration of biocide changes at the outlet of the dialyzer for 12 hours. The amount of biocide (in milligrams) that the dialyzer delivered after 12 hours was calculated using trapezoidal numerical integration. The EC meter stopped recording data at 2.5 hours, and the result continued after 30 minutes

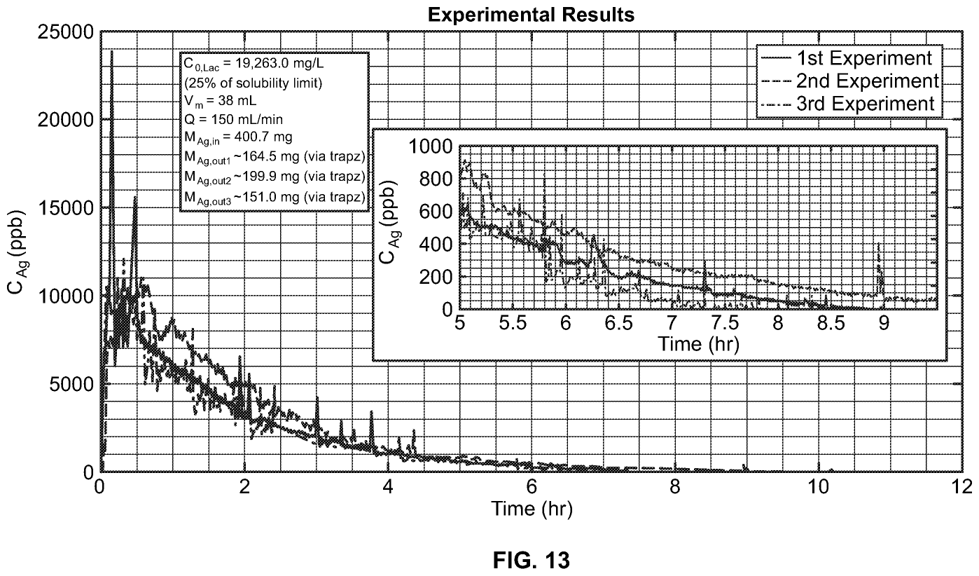

FIG. 13 graphically compares the biocide delivery rate for the results shown in FIGS. 10-12 as well as the amount of biocide consumed in 12 hours.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above-described embodiments, methods, and examples, but by all embodiments and methods within the scope and spirit of the disclosure.

What is claimed is:

1. A biocide delivery system comprising:
a feed tank in communication with a biocide source containing a biocide;
said biocide source adapted to receive water from said feed tank and controllably releases biocide into water received from said feed tank; and
a product tank in communication with said biocide source and adapted to receive water from said biocide source.

2. The biocide delivery system of claim 1 wherein said biocide source contains silver as said biocide.

3. The biocide delivery system of claim 2 wherein said biocide source is a membrane.

4. The biocide delivery system of claim 2 wherein said biocide source is a cartridge.

5. The biocide delivery system of claim 2 wherein said biocide source is a resin bed.

6. A biocide delivery system comprising:
a feed tank in communication with a first biocide source containing a biocide;
said first biocide source adapted to receive water from said feed tank and controllably releases biocide into water received from said feed tank;
a second biocide source containing a biocide in communication said first biocide source, said second biocide source controllably releases biocide into water received from said first biocide source;
a third biocide source containing a biocide in communication said second biocide source, said third biocide source controllably releases biocide into water received from said second biocide source; and
a product tank in communication with said third biocide source and adapted to receive water from said third biocide source.

7. The biocide delivery system of claim 6 wherein said first, second and third biocide sources contain silver as said biocide.

8. The biocide delivery system of claim 7 further including a plurality of valves in communication with said second biocide source, said plurality of valves form a feedback loop adapted to recirculate water within said second biocide source.

9. The biocide delivery system of claim 8 further including a fourth biocide source in communication with said second biocide source, said fourth biocide source replenishes biocide released by said second biocide source.

10. The delivery system of claim 9 further including a conductivity meter, said conductivity meter in communication with at least one of said valves.

11. The delivery system of claim 9 wherein said second biocide source is a cartridge.

12. The delivery system of claim 9 wherein said second biocide source is a resin bed.

13. The delivery system of claim 9 wherein said second biocide source is a membrane.

14. The delivery system of claim 9 wherein said second biocide source is a membrane.

15. A method of treating water with a biocide comprising the steps of:
providing a feed tank in communication with a first biocide source containing a biocide;
adapting said first biocide source to receive water from said feed tank and to controllably release biocide into water received from said feed tank and to controllably release biocide into water returned to said feed tank;
providing a second biocide source containing a biocide in communication said first biocide source, said second biocide source controllably releases biocide into water received from said first biocide source;
providing a third biocide source containing a biocide in communication said second biocide source, said third biocide source controllably releases biocide into water received from said second biocide source and to controllably release biocide into water returned to said second biocide source; and
providing a product tank in communication with said third biocide source and adapted to receive water from said third biocide source.

16. The biocide delivery method of claim 15 wherein said first, second and third biocide sources contain silver as said biocide.

17. The biocide delivery method of claim 16 further including a plurality of valves in communication with said second biocide source, said plurality of valves form a feedback loop adapted to recirculate water within said second biocide source.

18. The biocide delivery system of claim 17 further including a fourth biocide source in communication with said second biocide source, said fourth biocide source replenishes biocide released by said second biocide source.

19. The delivery system of claim 17 further including a conductivity meter, said conductivity meter in communication with at least one of said valves and controls the operation of at least one of said valves.

20. The delivery system of claim 19 wherein said second biocide source is a cartridge.

21. The delivery system of claim 19 wherein said second biocide source is a resin bed.

22. The delivery system of claim 19 wherein said second biocide source is a membrane.
